(19) United States
(12) Patent Application Publication
(10) Pub. No.: US 2010/0225713 A1
(43) Pub. Date: Sep. 9, 2010

(54) Liquid Ejecting Head and Image Forming Device

(76) Inventor: Sho Onozawa, Kanagawa (JP)

Correspondence Address: FISH & RICHARDSON P.C., PO BOX 1022, MINNEAPOLIS, MN, 55440-1022, US

(21) Appl. No.: 12/716,950

(22) Filed: Mar. 3, 2010

(30) Foreign Application Priority Data
Mar. 5, 2009 (JP) 2009052190

(51) Int. Cl. B41J 2/175

(52) U.S. Cl. 347/85; 347/101

(57) ABSTRACT

At an inkjet line head, pressure chambers are disposed, via plural ink supply paths, at both sides of a common flow path that stores ink. The pressure chambers communicate with nozzles that eject droplets. Cylindrical structural bodies are disposed within the common flow path, along a vertical direction of the common flow path within sections between extended lines of positions where the nozzles are disposed. The structural bodies are arranged cyclically in an order of one, two three structural bodies in the sections of the common flow path. A liquid ejecting head and image forming device are provided that suppress effects of crosstalk due to low frequency resonance, and accordingly, can suppress locality of crosstalk.

### CROSS-REFERENCE TO RELATED APPLICATION

This application claims priority under 35 USC 119 from Japanese Patent Application No. 2009-052190, filed on Mar. 5, 2009, the disclosure of which is incorporated by reference herein.

### BACKGROUND OF THE INVENTION

1. Field of the Invention

The present invention relates to a liquid ejecting head and an image forming device.

2. Description of the Related Art

In a single-pass inkjet recording device, the desired resolution must be realized by the recording medium passing only a single time, and therefore, the number of nozzles in the subscanning direction of the inkjet recording head is large of necessity. Accompanying this, the length of a common flow path that stores the liquid (ink or the like) becomes long, and the resonance frequency of the liquid within the common flow path decreases. If the resonance frequency falls to a vicinity of the ejecting frequency, the effects of so-called crosstalk, that affects the droplet ejecting characteristics among nozzles in accordance with the low frequency resonance at the common flow path, becomes severe. Here, crosstalk means the phenomenon of the ejecting operation at a given nozzle interfering with the ink of another nozzle such that the ejecting of the ink is disturbed.

There is locality in the effects of crosstalk. For example, at the time of ejecting from all of the nozzles, when focusing on a given row, the “number of driving nozzles at the periphery” are greatest at the center of the row, and therefore, the nozzles in a vicinity of the center of the row are affected particularly severely. Namely, the effects of crosstalk are locally greater in a vicinity of the center of a row.

Japanese Patent Application Laid-Open (JP-A) No. 2003-311965 discloses a structure in which, in one row of ejecting openings, ejecting openings for a large droplet size and ejecting openings for a small droplet size, whose opening diameters are smaller than those of the previous ejecting openings, are disposed alternately. Between the opening at the ink supply opening side of an ink flow path and the ink supply opening, one columnar filter is disposed per ink flow path.

However, in JP-A No. 2003-311965, the columnar filter is disposed between the opening at the ink supply opening side of the ink flow path that has an electricity-heat conversion element, and the ink supply opening. This is not a structure in which a columnar filter is provided at a common flow path. Therefore, the effects of crosstalk cannot be suppressed. Locality of crosstalk, that has a particularly severe effect on the nozzles in the vicinity of the center of a row in particular, cannot be effectively reduced, and there is room for improvement.

### SUMMARY OF THE INVENTION

In view of the above-described circumstances, an object of the present invention is to provide a liquid ejecting head and an image forming device that can suppress the effects of crosstalk due to low frequency resonance, and accordingly, can reduce locality of crosstalk.

A liquid ejecting head relating to a first aspect of the present invention includes: a plurality of pressure chambers communicating with nozzles, that eject droplets onto a recording medium, and in which a liquid is filled; a driving device for varying pressures of the pressure chambers and causing the droplets to be ejected from the nozzles; and a common flow path to which are connected a plurality of liquid supply paths that communicate respectively with the pressure chambers, the liquid flow path being elongated and storing the liquid that is supplied to the pressure chambers, wherein a cross-sectional surface area of the common flow path in a direction orthogonal to a longitudinal direction of the common flow path is changed in accordance with a position in the longitudinal direction of the common flow path.

In accordance with the invention of the first aspect, the plural liquid supply paths, that communicate respectively with the pressure chambers, are connected to the elongated common flow path that stores liquid. The liquid within the common flow path is supplied to the respective pressure chambers via the plural liquid supply paths. Due to the driving device (means) varying the pressures of the pressure chambers, the liquid is ejected as droplets onto the recording medium from the nozzles that communicate with the pressure chambers. The cross-sectional surface area in the direction orthogonal to the longitudinal direction of the common flow path is changed in accordance with the position. in the longitudinal direction of the common flow path. If the cross-sectional surface area in the direction orthogonal to the longitudinal direction of the common flow path (that will be called “the cross-sectional surface area of the common flow path” upon occasion hereinafter) is small, the fluid resistance is large. Due thereto, the effects of crosstalk due to low frequency resonance are suppressed. Further, for example, by making small the cross-sectional surface area of a position in the longitudinal direction of the common flow path that is easily affected by locality of crosstalk, dispersion of the fluid resistances of the respective nozzles in the longitudinal direction of the common flow path becomes smaller. Due thereto, dispersion in the effects of crosstalk among the respective nozzles becomes smaller, and locality of crosstalk can be reduced.

In the liquid ejecting head of the first aspect, the cross-sectional surface area may be changed cyclically along the longitudinal direction of the common flow path by structural bodies provided within the common flow path.

In accordance with the above-described configuration, the cross-sectional surface area of the common flow path is changed cyclically along the longitudinal direction of the common flow path by the structural bodies that are provided within the common flow path. Namely, by making the cross-sectional surface area of the common flow path small cyclically along the longitudinal direction of the common flow path by the structural bodies, the dispersion in the fluid resistances of the respective nozzles in the longitudinal direction of the common flow path becomes even smaller. Due thereto, dispersion in the effects of crosstalk among the respective nozzles becomes smaller, and locality of crosstalk can be reduced even more.

In the liquid ejecting head of the first aspect, the structural bodies may cyclically form narrowed regions at which the cross-sectional surface area is smallest in the longitudinal direction of the common flow path, and cyclically form intermediate narrowed regions at which the cross-sectional surface area is next largest after the narrowed regions, such that an interval is narrower than an interval in the longitudinal direction between the narrowed regions, and cyclically form one or plural regions at which the cross-sectional surface areas are successively larger than at the intermediate narrowed regions, such that intervals are successively narrower than an interval in the longitudinal direction between the intermediate narrowed regions. That is, the structural bodies may includes a first group of structural bodies that cyclically forms first narrowed regions at which the cross-sectional surface area is smallest in the longitudinal direction of the common flow path, a second group of structural bodies that cyclically forms second narrowed regions at which the cross-sectional surface area is next larger than the first narrowed regions, such that an interval in the longitudinal direction of the common flow path between the respective second narrowed regions is narrower than an interval in the longitudinal direction between the respective first narrowed regions, and a third group of structural bodies cyclically forms third narrowed regions at which the cross-sectional surface area is successively larger than at the second narrowed regions, such that an interval in the longitudinal direction of the common flow path between the respective third narrowed regions is successively narrower than an interval in the longitudinal direction between the respective second narrowed regions.

In the liquid ejecting head of the first aspect, the structural bodies cyclically form narrowed regions at which the cross-sectional surface area of the common flow path in the longitudinal direction of the common flow path is smallest. The structural bodies cyclically form intermediate narrowed regions at which the cross-sectional surface area of the common flow path is next largest after the aforementioned narrowed regions, such that the interval therebetween is narrower than the interval in the longitudinal direction between the narrowed regions. The structural bodies cyclically form one or plural regions at which the cross-sectional surface areas of the common flow path are successively larger than at the intermediate narrowed regions, such that the intervals therebetween are successively narrower than the interval in the longitudinal direction between the intermediate narrowed regions. Due to the narrowed regions, the intermediate narrowed regions, and the other regions at which the cross-sectional surface area of the common flow path is larger than that at the intermediate narrowed regions, that are structured by the structural bodies in this way, being formed in a multi-repeat cycle (repeating cycle), dispersion in the fluid resistances of the respective nozzles in the longitudinal direction of the common flow path becomes even smaller. Due thereto, dispersion in the effects of crosstalk among the respective nozzles becomes even smaller, and locality of crosstalk can be reduced more effectively.

In the liquid ejecting head of the first aspect, the structural bodies may be one or more columnar members disposed in a direction intersecting the longitudinal direction of the common flow path.

In the above configuration, the structural bodies are one or more columnar members disposed in a direction intersecting the longitudinal direction of the common flow path. By changing the cross-sectional surface area of the common flow path by a simple structure, the effects of crosstalk due to low frequency resonance are suppressed, and accordingly, locality of crosstalk can be reduced.

An image forming device relating to a second aspect of the present invention has: the liquid ejecting head of the first aspect; and a conveying mechanism for conveying a recording medium to a position facing the liquid ejecting head, wherein the image forming device forms an image by causing the recording medium to pass the position facing the liquid ejecting head.

In accordance with the second aspect of the invention, an image is formed due to a recording medium being conveyed by the conveying means to the position facing the liquid ejecting head of the first aspect, and the recording medium being made to pass the position facing the liquid ejecting head. The cross-sectional surface area in the direction orthogonal to the longitudinal direction of the common flow path of the liquid ejecting head is changed in accordance with the position in the longitudinal direction of the common flow path. By making the cross-sectional surface area of the common flow path small, the fluid resistance becomes larger. Due thereto, the effects of crosstalk due to low frequency resonance are suppressed. Further, for example, by making small the cross-sectional surface area of a position in the longitudinal direction of the common flow path that is easily affected by locality of crosstalk, dispersion in the effects of crosstalk among the respective nozzles becomes smaller, and locality of crosstalk can be reduced.

In accordance with the present invention, the effects of crosstalk due to low frequency resonance are suppressed, and accordingly, locality of crosstalk can be reduced.

### BRIEF DESCRIPTION OF THE DRAWINGS

FIG. 1 is an overall structural drawing showing the structure of an image forming device equipped with inkjet line heads relating to a first exemplary embodiment of the present invention;

FIG. 2 is a perspective plan view showing the structure of the inkjet line head relating to the first exemplary embodiment;

FIG. 3 is a transparent perspective view showing the structure of the inkjet line head relating to the first exemplary embodiment;

FIG. 4 is a cross-sectional view showing the structures of a common flow path and a vicinity of a pressure chamber of the inkjet line head relating to the first exemplary embodiment;

FIG. 5 is a plan view showing an array of structural bodies that are arranged within the common flow path of the inkjet line head relating to the first exemplary embodiment;

FIG. 6 is a graph showing the relationship between position n of a nozzle and resistance from the 0th nozzle to an nth nozzle, at the common flow path shown in FIG. 5; and

FIG. 7 is a graph showing the relationship between position n of a nozzle and resistance Rₙ from the 0th nozzle to an nth nozzle, at a common flow path of an inkjet line head relating to a second exemplary embodiment.

### DETAILED DESCRIPTION OF THE INVENTION

### First Exemplary Embodiment

An image forming device, that is equipped with an inkjet line head serving as a liquid ejecting head relating to a first exemplary embodiment of the present invention, will be described hereinafter.

First, the overall structure of an image forming device 10 will be described.

<Image Forming Device>

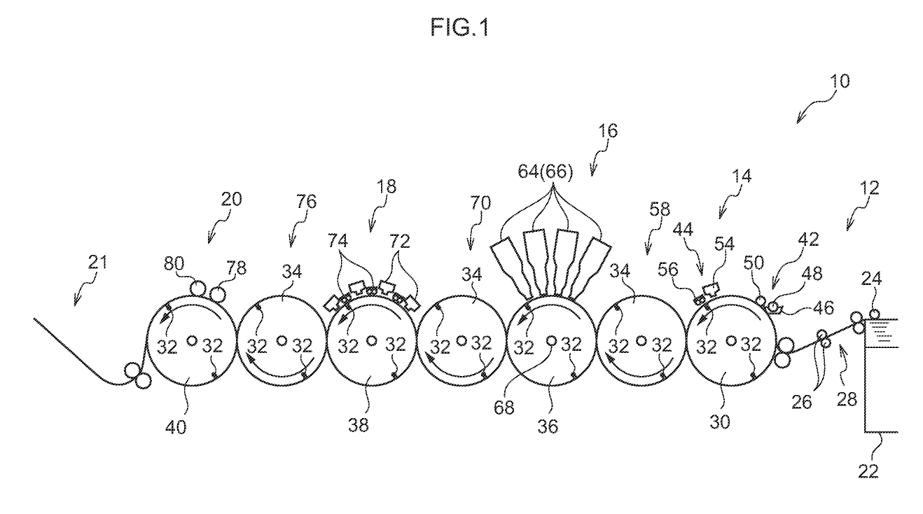

As shown in FIG. 1, a feeding/conveying section 12 that feeds and conveys sheets is provided at the image forming device 10 relating to the present exemplary embodiment, at the upstream side in the conveying direction of sheets that serve as recording media. Provided along the sheet conveying direction at the downstream side of the feeding/conveying section 12 are: a processing liquid coating section 14 that coats a processing liquid on a recording surface of the sheet, an image forming section 16 that forms an image on the recording surface of the sheet, an ink drying section 18 that dries the image formed on the recording surface, an image fixing section 20 that fixes the dried image to the sheet, and a discharging section 21 that discharges the sheet on which the image is fixed.

The respective processing sections will be described hereinafter.

### (Feeding/Conveying Section)

A stacking section 22 in which sheets are stacked is provided at the feeding/conveying section 12. A sheet feed portion 24, that feeds one-by-one the sheets that are stacked in the stacking section 22, is provided at the downstream side in the sheet conveying direction (there are cases hereinafter in which “in the sheet conveying direction” is omitted) of the stacking section 22. The sheet that is fed by the sheet feed portion 24 is conveyed to the processing liquid coating section 14 via a conveying portion 28 that is structured by plural roller pairs 26.

### (Processing Liquid Coating Section)

A processing liquid coating drum 30 is disposed at the processing liquid coating section 14 so as to be rotatable. Holding members 32, that nip the leading end portions of sheets and hold the sheets, are provided at the processing liquid coating drum 30. In the state in which a sheet is held at the surface of the processing liquid coating drum 30 via the holding member 32, the sheet is conveyed to the downstream side by the rotation of the processing liquid coating drum 30.

In the same way as at the processing liquid coating drum 30, the holding members 32 are provided as well at intermediate conveying drums 34, an image forming drum 36, an ink drying drum 38 and a fixing drum 40 that will be described later. Further, the transfer of a sheet from an upstream side drum to a downstream side drum is carried out by the holding members 32.

A processing liquid coating device 42 and a processing liquid drying device 44 are disposed along the peripheral direction of the processing liquid coating drum 30 at the upper portion of the processing liquid coating drum 30. Processing liquid is coated onto the recording surface of the sheet by the processing liquid coating device 42, and the processing liquid is dried by the processing liquid drying device 44.

Here, the processing liquid reacts with ink, aggregates the color material (pigment), and has the effect of promoting separation of the color material (pigment) and the solvent. A storing portion 46, in which the processing liquid is stored, is provided at the processing liquid coating device 42, and a portion of a gravure roller 48 is soaked in the processing liquid.

A rubber roller 50 is disposed so as to press-contact the gravure roller 48. The rubber roller 50 contacts the recording surface (obverse) side of the sheet such that the processing liquid is coated thereon. Further, a squeegee (not shown) contacts the gravure roller 48 and controls the processing liquid coating amount that is coated on the recording surface of the sheet.

It is ideal that the film thickness of the processing liquid is sufficiently smaller than the droplet ejected by the head. For example, if the ejected droplet amount is 2 μl, the average diameter of the droplet ejected by the head is 15.6 μM. If the film thickness of the processing liquid is thick, the ink dot floats within the processing liquid without contacting the recording surface of the sheet. It is preferable to make the film thickness of the processing liquid be less than or equal to 3 μm in order to obtain a landed dot diameter of greater than or equal to 30 μm at an ejected droplet amount of 2 μl.

On the other hand, at the processing liquid drying device 44, a hot air nozzle 54 and an infrared heater 56 (hereinafter called “IR heater 56”) are disposed near to the surface of the processing liquid coating drum 30. The solvent such as water or the like within the processing liquid is vaporized by the hot air nozzle 54 and the IR heater 56, and a solid or thin-film processing liquid layer is formed on the recording surface side of the sheet. By making the processing liquid be a thin layer in the processing liquid drying process, the dots of ink that are ejected at the image forming section 16 contact the sheet surface such that the necessary dot diameter is obtained, and the actions of reacting with the processing liquid that has been made into a thin layer, aggregating the pigment, and fixing to the sheet surface are easily obtained.

The sheet, on whose recording surface the processing liquid has been coated and dried at the processing liquid coating section 14 in this way, is conveyed to an intermediate conveying section 58 that is provided between the processing liquid coating section 14 and the image forming section 16.

(Intermediate Conveying Section)

The intermediate conveying drum 34 is provided at the intermediate conveying section 58 so as to be rotatable. A sheet is held at the surface of the intermediate conveying drum 34 via the holding member 32 provided at the intermediate conveying drum 34, and the sheet is conveyed to the downstream side by the rotation of the intermediate conveying drum 34.

(Image Forming Section)

The image forming drum 36 is provided at the image forming section 16 so as to be rotatable. A sheet is held at the surface of the image forming drum 36 via the holding member 32 provided at the image forming drum 36, and the sheet is conveyed to the downstream side by the rotation of the image forming drum 36.

Head units 66, that are structured by single-pass inkjet line heads 64, are disposed at the upper portion of the image forming drum 36 so as to be near the surface of the image forming drum 36. At the head units 66, the inkjet line heads 64 of at least YMCK that are basic colors are arrayed along the peripheral direction of the image forming drum 36, and form images of the respective colors on the processing liquid layer that was formed on the recording surface of the sheet at the processing liquid coating section 14. The inkjet line head 64 has a length corresponding to the maximum sheet width of the sheets that are the objects of the image forming device 10. Plural nozzles 110 for ink ejection are arrayed at the nozzle surface of the inkjet line head 64 over a length exceeding at least one side of the sheet of the maximum size (i.e., over the entire width of the printable range).

The processing liquid has the effect of making the color material (pigment) and the latex particles that are dispersed within the ink aggregate in the processing liquid, and forms aggregates at which flowing of the color material and the like do not arise on the sheet. As an example of the reaction between the ink and the processing liquid, by using a mechanism in which pigment dispersion is destroyed and aggregates are formed by including an acid within the processing liquid and lowering the pH, running of the color material, color mixing between the inks of the respective colors, and ejected drop interference due to uniting of liquids at the time when the ink drops land are avoided.

The inkjet line heads 64 carry out ejecting of droplets synchronously with an encoder (not illustrated) that is disposed at the image forming drum 36 and detects the rotating speed. Due thereto, the landing positions of the droplets are determined highly accurately, and non-uniform droplet ejection can be reduced independently of deviations of the image forming drum 36, the precision of a rotating shaft 68, or the surface speed of the drum.

Note that the head units 66 can be withdrawn from the upper portion of the image forming drum 36. Maintenance operations such as cleaning of the nozzle surfaces of the inkjet line heads 64, expelling of ink whose viscosity has increased, and the like are carried out by withdrawing the head units 66 from the upper portion of the image forming drum 36.

Due to the rotation of the image forming drum 36, the sheet, on whose recording surface an image is formed, is conveyed to an intermediate conveying section 70 that is provided between the image forming section 16 and the ink drying section 18. Because the structure of the intermediate conveying section 70 is substantially the same as that of the intermediate conveying section 58, description thereof is omitted.

(Ink Drying Section)

The ink drying drum 38 (to be described later) is provided at the ink drying section 18 so as to be rotatable. Plural hot air nozzles 72 and IR heaters 74 are disposed at the upper portion of the ink drying drum 38 so as to be near the surface of the ink drying section 18.

Here, as an example, the hot air nozzles 72 are disposed at the upstream side and the downstream side, and pairs of IR heaters 74 that are lined-up in parallel are disposed alternately with the hot air nozzles 72. Other than this, numerous IR heaters 74 may be disposed at the upstream side and a large amount of thermal energy irradiated and the temperature of the moisture raised at the upstream side, whereas, at the downstream side, numerous hot air nozzles 72 may be disposed and the saturated water vapor blown-away.

Here, the hot air nozzles 72 are disposed such that the angle at which the hot air is blown out is inclined toward the trailing end side of the sheet. Due thereto, the flow of hot air from the hot air nozzles 72 can be collected in one direction. Further, the sheet can be pushed against the ink drying drum 38, and the state in which the sheet is held at the surface of the ink drying drum 38 can be maintained.

Due to the warm air from the hot air nozzles 72 and the IR heaters 74, at the portion of the sheet where the image is formed, the solvent that is separated by the color material aggregating action is dried, and a thin-film image layer is formed.

Although it depends also on the conveying speed of the sheet, the warm air is usually set to 50° C. to 70° C., and the temperature of the IR heaters 74 is set to 200° C. to 600° C. The ink surface temperature is thereby set to become 50° C. to 60° C. The evaporated solvent is discharged to the exterior of the image forming device 10 together with air, but the air is recovered. This air may be cooled by a cooler/radiator or the like, and recovered as liquid.

Due to the rotation of the ink drying drum 38, the sheet, on whose recording surface the image is dried, is conveyed to an intermediate conveying section 76 that is provided between the ink drying section 18 and the image fixing section 20. Because the structure of the intermediate conveying section 76 is substantially the same as that of the intermediate conveying section 58, description thereof is omitted.

(Image Fixing Section)

The image fixing drum 40 is provided at the image fixing section 20 so as to be rotatable. At the image fixing section 20, the latex particles within the image layer, that is a thin layer formed on the ink drying drum 38, are subjected to heat and pressure and fused, and the image fixing section 20 has the function of fixing them on the sheet.

A heating roller 78 is disposed at the upper portion of the image fixing drum 40 so as to be near the surface of the image fixing drum 40. At the heating roller 78, a halogen lamp is built-in within a metal pipe of aluminum or the like that has good thermal conductivity, and thermal energy of greater than or equal to the Tg temperature of the latex is provided by the heating roller 78. Due thereto, the latex particles fuse and push-in fixing into the indentations and protrusions on the sheet is carried out, and the unevenness of the surface of the image can be leveled and glossiness can be obtained.

A fixing roller 80 is provided at the downstream side of the heating roller 78. The fixing roller 80 is disposed in a state of press-contacting the surface of the image fixing drum 40, and nipping force is obtained between the fixing roller 80 and the image fixing drum 40. Therefore, at least one of the fixing roller 80 and the image fixing drum 40 has an elastic layer at the surface thereof, and has a uniform nip width with respect to the sheet.

The sheet, on whose recording surface an image is fixed by the above-described processes, is conveyed by the rotation of the image fixing drum 40 toward the discharging section 21 side that is provided at the downstream side of the image fixing section 20.

Note that, although the image fixing section 20 is described in the present exemplary embodiment, it suffices to be able to, at the ink drying section 18, dry and fix the image that is formed on the recording surface. Therefore, the image fixing section 20 is not absolutely necessary.

The inkjet line head 64, that serves as a liquid ejecting head relating to the first exemplary embodiment of the present invention, will be described next.

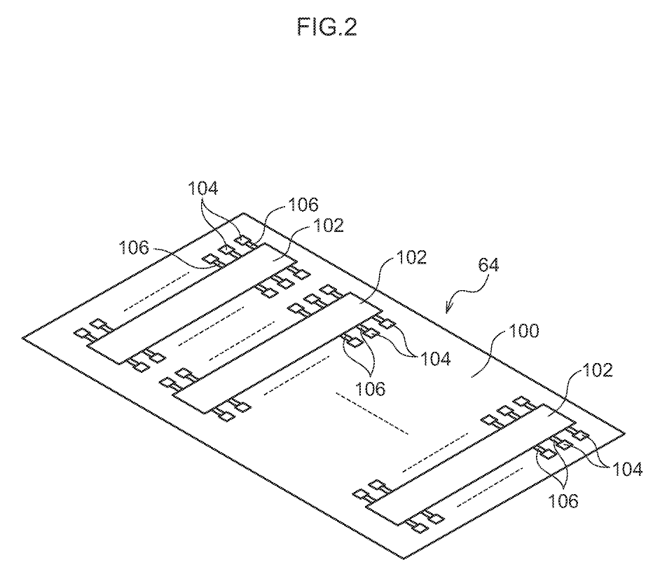

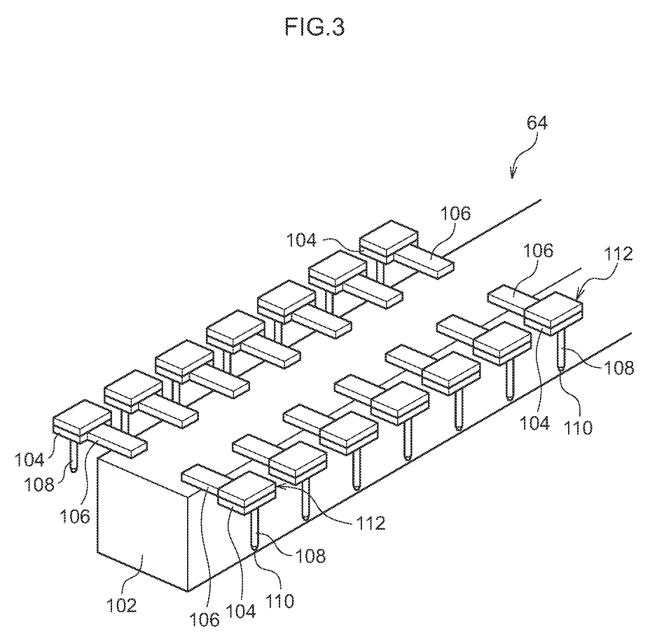

The structure of the inkjet line head 64 is shown in a perspective plan view in FIG. 2. Further, the structure of the inkjet line head 64 is shown in a transparent perspective view in FIG. 3. As shown in these figures, at the inkjet line head 64, plural common flow paths 102, that are elongated and store ink, are lined-up at substantially uniform intervals at a housing 100 that structures the head portion.

Plural ink supply paths 106, that serve as liquid supply paths and respectively communicate with pressure chambers 104, are provided at both sides that run along the longitudinal direction of the common flow path 102. One end of the ink supply path 106 communicates with the top surface portion of the common flow path 102, and the other end communicates with the pressure chamber 104. The plural ink supply paths 106 extend substantially parallel at the both sides of the common flow path 102. The ink within the common flow path 102 is distributed and supplied to the respective pressure chambers 104 via the respective ink supply paths 106. Note that, although not illustrated, an ink introducing port, through which ink is supplied to the interior of the common flow path 102, is provided at one longitudinal direction end portion of the common flow path 102, and an ink discharge port, through which ink is discharged from the interior of the common flow path 102, is provided at the other longitudinal direction end portion of the common flow path 102.

The shape, in plan view, of the pressure chamber 104 is approximately square. The ink supply path 106 is connected to the intermediate portion of one side of the pressure chamber 104. A flow-out port 108, that communicates with a nozzle 110, is provided in a vicinity of the one side of the pressure chamber 104 that is at the side opposite the ink supply path 106. Note that the shape of the pressure chamber 104 is not limited to that of the present example, and the plan view shape may be any of various forms such as quadrangular (rhomboid, rectangular, or the like), pentagonal, hexagonal, another polygon shape, circular, oval or the like. Further, there may be a structure in which the ink supply path 106 is connected to one of the corner portions on a diagonal line of a quadrangular pressure chamber, and the flow-out port 108 is disposed at the other corner portion.

The respective pressure chambers 104 are disposed, via the plural ink supply paths 106, at both sides of each of the plural common flow paths 102 that are lined-up. Due thereto, the plural pressure chambers 104 corresponding to the respective nozzles 110 are disposed in the form of a matrix.

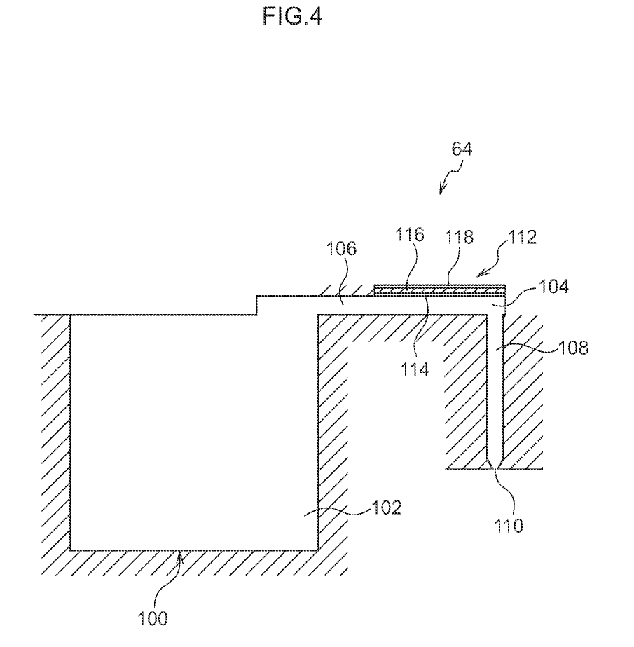

As shown in FIG. 4, a driving device 112 serving as a driving means is disposed at the top portion of the pressure chamber 104. The driving device 112 has a pressure-applying plate 114 (a vibrating plate that also functions as a common electrode) structuring the top surface of the pressure chamber 104, a piezoelectric body 116 provided at the top portion of the pressure-applying plate 114, and an individual electrode 118 provided at the top surface of the piezoelectric body 116. Due to driving voltage being applied between the individual electrode 118 and the common electrode, the piezoelectric body 116 deforms and the volume of the pressure chamber 104 changes, and ink is ejected from the nozzle 110 due to the change in pressure accompanying this. After ink is ejected, when the displacement of the piezoelectric body 116 returns to the original state, new ink is replenished into the pressure chamber 104 from the common flow path 102 through the ink supply path 106.

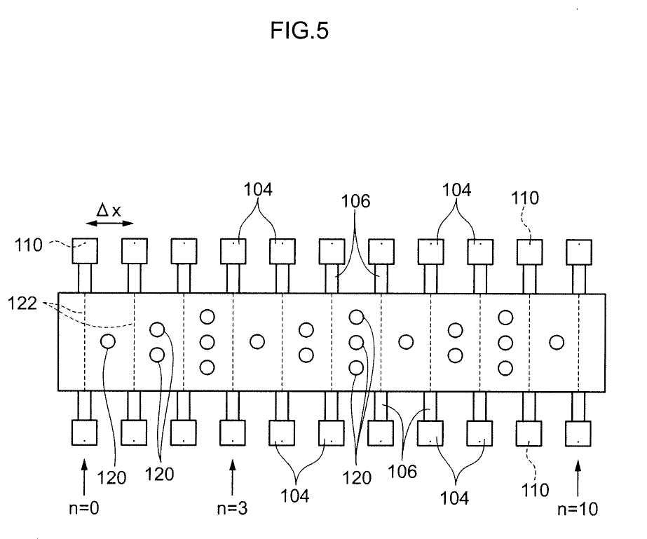

As shown in FIG. 5, one to three cylindrical (columnar) structural bodies 120 are disposed within the common flow path 102, between positions at which the nozzles 110 of the respective pressure chambers 104 are disposed (extended lines of the positions at which the nozzles 110 are disposed are shown by the dashed lines 122). The structural bodies 120 are disposed in a direction (in the present exemplary embodiment, in the vertical direction of the common flow path 102) orthogonal to the longitudinal direction of the common flow path 102. Among the dashed lines 122 in FIG. 5, n=0 shows the extended line of the position at which there is the 0th nozzle 110 from an end portion of the common flow path 102, and n=3 shows the extended line of the position at which there is the 3rd nozzle 110 from the end portion of the common flow path 102. In the sections between these dashed lines 122, one, two, three of the structural bodies 120 are lined-up, and thereafter, these numbers of the structural bodies 120 that are set continue cyclically along the longitudinal direction of the common flow path 102. When there is one of the structural bodies 120, that structural body 120 is disposed at the middle in the transverse direction of the common flow path 102. When there are two or three of the structural bodies 120, they are disposed in a row in uniform intervals in the transverse direction of the common flow path 102.

By placing one to three of the structural bodies 120 in the sections of the dashed lines 122 of the common flow path 102, the cross-sectional surface area in the direction orthogonal to the longitudinal direction of the common flow path 102 changes cyclically. Namely, as the number of the structural bodies 120 that are set increases, the cross-sectional surface area in the direction orthogonal to the longitudinal direction of the common flow path 102 is blocked and reduced, and the common flow path 102 can be narrowed cyclically.

Next, the arrangement of the structural bodies 120 at the inkjet line head 64 of the present exemplary embodiment will be investigated, and the operation and effects of the inkjet line head 64 will be explained.

The absolute value of the effects of crosstalk between the nozzles 110 is inversely proportional to the fluid resistance between the nozzles 110. Accordingly, if the fluid resistance within the common flow path 102 is increased, the absolute value of the crosstalk decreases, i.e., it can be made difficult to be affected by crosstalk.

The resistance of a jth section of the common flow path 102 is expressed by formula I.

$$[ Formula 1 ]$$

$${ρ}_{j} = \frac{Δ x}{{( A - {aN}_{j} )}^{2}} \qquad ( 1 )$$

In formula I, Δx is the length of a section between the dashed lines 122 in the longitudinal direction of the common flow path 102, A is the cross-sectional surface area in the direction orthogonal to the longitudinal direction of the common flow path 102 (the cross-sectional surface area in the direction parallel to the dashed lines 122), a is the cross-sectional surface area blocked by one of the structural bodies 120 (the cross-sectional surface area in the direction parallel to the dashed lines 122), and Nⱼ is the number of the structural bodies 120 that are set. The resistance from the 0th nozzle 110 to the nth nozzle 110 is expressed by following formula (2).

$$[ Formula 2 ]$$

$${R}_{n} = {\sum }_{j = 1}^{n} {ρ}_{j} \qquad ( 2 )$$

The cyclical repetition of one, two, three of the structural bodies 120 can be expressed by using the discrete sawtooth function of formula (3).

$$[ Formula 3 ]$$

$${N}_{j} = R ( 2 + \frac{1}{π} [ i ( ln ( 1 - {e}^{- i \frac{2 π}{a} ( j - \frac{1}{2} )} ) - ln ( 1 - {e}^{i \frac{2 π}{a} ( j - \frac{1}{2} )} ) ) ] ) , \\ a = 3 \qquad ( 3 )$$

Here, R(f) is a function that rounds the function value f to an integer (replaces it with an integer by rounding or truncating or the like).

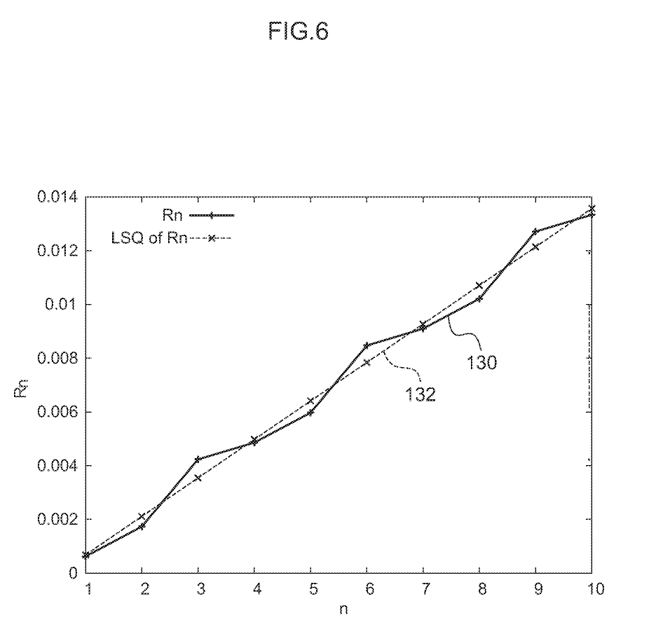

When resistance Rₙ from the 0th nozzle 110 to the nth nozzle 110 is computed, the results are a graph such as shown in FIG. 6. In FIG. 6, n is on the horizontal axis, and Rₙ is on the vertical axis. In computing Rₙ, values are set as Δx=1, A=50, a=5. A solid line 130 in FIG. 6 shows at the position of the nth nozzle 110, and a dashed line 132 shows an approximation in accordance with the method of least squares.

Here, the method of least squares is a method that determines coefficients that make the sum of squared residuals a minimum, so that a hypothesized function well approximates measured values, when approximating a group of numerical values, that are obtained by measurement, by using a specific function such as a linear function or the like that is hypothesized from an appropriate model. In more detail, a physical amount x′ (independent variable) is changed, and a physical amount y (dependent variable) that changes due thereto is plotted on a graph, and the relationship between the both obtained thereby is expressed as y=cx′+d. At this time, because errors are included in the measured values, the optimal line must be drawn while taking dispersion into consideration. In accordance with the principles of the method of least squares, the optimal line is the line at which the sum of squares of the offsets of the respective points from the drawn line becomes a minimum.

As shown by the solid line 130 in FIG. 6, it can be understood that the resistance Rₙ from the 0th nozzle 110 to the nth nozzle 110 varies in three cycles. Further, at six sections among the total nine sections, the gradient is smaller than the gradient that is in accordance with the method of least squares (the dashed line 132). This shows that, due to the cyclical arrangement of the structural bodies 120, the effects of crosstalk can be smoothed at about 67% more of the sections than a case in which structural bodies are disposed uniformly at all of the sections (e.g., a case in which two of the structural bodies are provided at each of all of the sections). Namely, by making the gradient smaller than the gradient that is in accordance with the method of least squares, the dispersion in the fluid resistances of the respective nozzles 110 is decreased, and the dispersion in the effects of crosstalk among the respective nozzles 110 (in particular, between nozzles 110 that are adjacent) is decreased. Of course, the effects of crosstalk conversely become more acute in the remaining approximately 33% of the sections. However, because there is also the possibility, in terms of probability theory, that these sections will not be used in the ejecting of droplets, this is reasonable as a selection that emphasizes reducing locality of crosstalk as in the present invention.

In the inkjet line head 64, one to three of the structural bodies 120, that change the cross-sectional surface area in a direction orthogonal to the longitudinal direction of the common flow path 102, are disposed in the sections between the dashed lines 122 within the common flow path 102. The fluid resistance within the common flow path 102 increases due to the structural bodies 120. Due thereto, the effects of crosstalk due to low frequency resonance can be suppressed. Further, because the numbers of the structural bodies 120 that are set are arranged cyclically (in three cycles) in the order of one, two, three of the structural bodies 120, dispersion in the fluid resistances among the respective nozzles 110 in the longitudinal direction of the common flow path 102 becomes smaller. Due thereto, dispersion in the effects of crosstalk among the respective nozzles 110 (between adjacent nozzles 110 in particular) becomes smaller, and the locality of crosstalk can be reduced.

### Second Exemplary Embodiment

An inkjet line head serving as a liquid ejecting head relating to a second exemplary embodiment of the present invention will be described next. Note that structural portions that are the same as those of the above-described first exemplary embodiment are denoted by the same reference numerals, and description thereof is omitted.

In the inkjet line head 64 of the first exemplary embodiment, there are the three types, that are one, two, three, of the number of the structural bodies 120 that are set. Because there are three cycles in the entire longitudinal direction of the common flow path 102, the cycle is a one-repeat cycle (a structure in which sets of the “one, two, three” structural bodies 120 are lined-up).

In the inkjet line head of the second exemplary embodiment, the numbers of the structural bodies 120 are arranged in a multi-repeat cycle (repeating cycle) along the longitudinal direction of the common flow path 102. A multi-repeat cycle is a structure in which the numbers of the structural bodies 120 are arranged such that plural cycles repeat. For example, when there are three types of numbers of structural bodies 120 that are a, b, c (a<b<c), the structural bodies 120 are disposed as shown by series (4) in the sections between the dashed lines 122 within the common flow path 102.

[Formula 4]

(a<b<c) a,a,a,b,a,a,c,b,a,a,a,b,a,c,a,b,a,a,a,b,c, a,a,b,a,a,a,c,a,a,a,b,a,a,c,b,a,a,a,b, (4)

At first glance, it appears as if a, b, c, are lined-up randomly in series (4). However, for example, when moving toward the right from a given place where there is an a, basically, a appears first (namely, the letter right next thereto is again an a), and b appears fourth, and c appears seventh. The a is negated by b (i.e., the a is not a, and is replaced by b that is larger than a) in four cycles that is the least common multiple with the cycle of b. The b is negated by c (i.e., the b is not b, and is replaced by c that is larger than b) in 28 cycles that is the least common multiple with the cycle of c.

In other words, first, the c structural bodies 120, that are narrowed regions where the cross-sectional surface area of the common flow path 102 (the cross-sectional surface area in the direction parallel to the dashed lines 122) is smallest, are disposed at seven cycles. Next, the b structural bodies 120, that are intermediate narrowed regions where the cross-sectional surface area of the common flow path 102 is next largest after the c structural bodies 120, are disposed at four cycles. The b is not placed at a position where the c is already placed (b is negated by c). Further, the a structural bodies 120, that are regions where the cross-sectional surface area of the common flow path 102 is next largest after the b structural bodies 120, are disposed at the remaining sections.

In order to make it such that the above-described negation occurs as infrequently as possible, it is desirable to make the cycles be mutually prime. Therefore, for example, means such as selecting the cycles from among prime numbers such as 1, 2, 3, 5, 7, 9, . . . and the like, or the like, can be considered.

As described above, positioning is carried out from the structural bodies 120 of the largest number such that the intervals therebetween in the longitudinal direction of the common flow path 102 are wide, and then the structural bodies 120 of successively smaller numbers are positioned such that the intervals therebetween in the longitudinal direction of the common flow path 102 are narrower. Due thereto, the greatest effects of crosstalk at wide sections of the common flow path 102 can be suppressed by the c structural bodies 120 that are the largest number of the structural bodies 120, and the effects of crosstalk of the sections between the c structural bodies 120 can be suppressed by the b structural bodies 120 whose number is next largest after c, and the effects of crosstalk of the sections between the b structural bodies 120 can be suppressed by the a structural bodies 120 whose number is next largest after b. In a structure in which a, b, c, are arrayed in a multi-repeat cycle in this way, it is thought that the locality of crosstalk can be effectively reduced as compared with a case in which the a, b, c are arrayed in a one-repeat cycle.

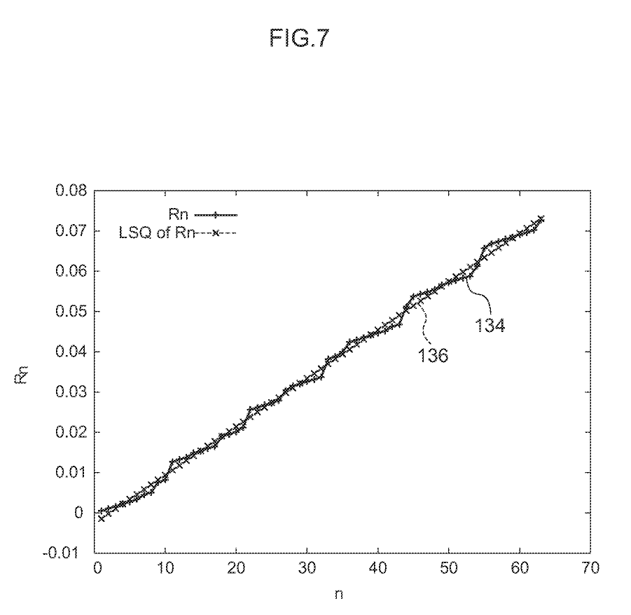

FIG. 7 illustrates the relationship between n and Rₙ when the structural bodies 120 of the numbers shown in series (5) are set between the nozzles 110, when there are 64 of the nozzles 110 along the longitudinal direction of the common flow path 102. In computing Rn, values are set as Δx=1, A=50, a=5. A solid line 134 in FIG. 7 shows Rₙ at the position of the nth nozzle 110, and a dashed line 136 shows an approximation in accordance with the method of least squares.

[Formula 5]

1,2,1,2,1,2,4,2,6,2,7,2,1,4,1,2,1,6,1,2,4,7,1,2,1,2,6,4,1 2,1,2,7,2,4,6,1,2,1,2,1,4,1,7,6,2,1,2,4,2,1,2,1,6,7,4,1,2,1,2,1,2,6 (5)

In series (5), the seven structural bodies 120, that is the largest number of the structural bodies 120 in the longitudinal direction of the common flow path 102 (the narrowed regions where the cross-sectional surface area of the common flow path 102 is smallest), are disposed at 11 cycles. Six structural bodies 120, that is the next largest number of the structural bodies 120 after the seven (intermediate narrowed regions at which the cross-sectional surface area of the common flow path 102 is larger than at the seven), are disposed at nine cycles. If seven of the structural bodies 102 are already placed, the six is negated. Then, four structural bodies 120, that is next largest number of the structural bodies 120 after the six (narrowed regions where the cross-sectional surface area of the common flow path 102 is greater than at the six), are disposed at seven cycles. If seven or six of the structural bodies 102 are already placed, the four is negated. Then, two structural bodies 120, that is next largest number of the structural bodies 120 after the four (narrowed regions where the cross-sectional surface area of the common flow path 102 is greater than at the four), are disposed at two cycles. If seven, six or four of the structural bodies 102 are already placed, the two is negated. Further, one structural body 120, that is the smallest number of the structural bodies 120 (narrowed regions where the cross-sectional surface area of the common flow path 102 is greater than at the two), is disposed at one cycle. If seven, six, four or two of the structural bodies 102 are already placed, the one is negated.

As shown in FIG. 7, among all of the 62 sections between the positions at which the 64 of the nozzles 110 are disposed, at 50 of these sections, the gradient of Rₙ is smaller than the gradient in accordance with the method of least squares (the dashed line 136). Namely, smoothing of the effects of crosstalk is achieved at about 81% more of the sections than a case in which the numbers of the structural bodies are set uniformly at all of the sections. Further, changes that are that drastic do not arise at the remaining 19%. The average value (expected value) of the gradients of the respective sections is 1.165×10⁻³, which is approximately 3% smaller than gradient 1.201×10⁻³ in accordance with the method of least squares. In terms of probability theory, this means that the effects of crosstalk are surely smoothed.

As described above, in a structure in which one, two, four, six, seven of the structural bodies 120 are arrayed in a multi-repeat cycle at the respective sections between the dashed lines 122 within the common flow path 102, the dispersion in fluid resistance among the nozzles 110 is smaller and the dispersion in the effects of crosstalk among the respective nozzles 110 (between adjacent nozzles 110 in particular) is smaller than a case in which one, two, four, six, seven of the structural bodies are arrayed in one-repeat cycles. Therefore, the locality of crosstalk can be effectively reduced.

[Supplementary Explanation]

The cylindrical structural bodies 120 are disposed in one row along the transverse direction of the common flow path (the direction orthogonal to the longitudinal direction), but the arrangement of the structural bodies is not limited to the same and may be another structure. For example, the structural bodies may be arranged in a direction intersecting the longitudinal direction of the common flow path, or may be structured so as to be arranged in a staggered form or in plural lines.

Although the structural bodies are disposed within the common flow path in the above-described first and second exemplary embodiments, the present invention is not limited to the same. For example, there may be a structure in which the wall surfaces themselves of the common flow path are made to protrude inwardly. Namely, “a cross-sectional surface area of the common flow path in a direction orthogonal to a longitudinal direction of the common flow path is changed in accordance with a position in the longitudinal direction of the common flow path” in the first aspect of the present invention is a gist including both cases of providing structural bodies within the common flow path, and structures in which the wall surfaces of the common flow path are themselves made to protrude inwardly.

In the first and second exemplary embodiments, the thickness of the cylindrical structural bodies 120 are the same, and the number of the structural bodies 120 is changed. However, the thickness of the structural bodies may be varied. Or, both the thickness and the number of the structural bodies may be varied.

The cylindrical structural bodies 120 are arranged in the above-described first and second exemplary embodiments. However, columnar members of other shapes, such as long-circular or oval columns, prisms (e.g., triangular prisms, quadrangular prisms, hexagonal prisms), or the like may be arranged. Further, the structural bodies are not limited to columnar members, and structural bodies of other shapes, such as plate-shaped members or the like, may be disposed.

Although the above first and second exemplary embodiments are structured such that ink is stored in the common flow path, the present invention is not limited to ink and may be structured so as to store a liquid such as another processing liquid or the like.

What is claimed is:

1. A liquid ejecting head comprising:
a plurality of pressure chambers communicating with nozzles, that eject droplets onto a recording medium, and in which a liquid is filled;
a driving device for varying pressures of the pressure chambers and causing the droplets to be ejected from the nozzles; and
a common flow path to which are connected a plurality of liquid supply paths that communicate respectively with the pressure chambers, the liquid flow path being elongated and storing the liquid that is supplied to the pressure chambers,
wherein a cross-sectional surface area of the common flow path in a direction orthogonal to a longitudinal direction of the common flow path is changed in accordance with a position in the longitudinal direction of the common flow path.

2. The liquid ejecting head of claim 1, wherein structural bodies are provided within the common flow path, thereby causing the cross-sectional surface area of the common flow path to be changed.

3. The liquid ejecting head of claim 1, wherein the cross-sectional surface area of the common flow path is changed cyclically along the longitudinal direction of the common flow path.

4. The liquid ejecting head of claim 1, wherein the cross-sectional surface area of the common flow path is changed cyclically along the longitudinal direction of the common flow path by structural bodies provided within the common flow path.

5. The liquid ejecting head of claim 1, wherein the cross-sectional surface area of the common flow path is changed in a multi-repeat cycle along the longitudinal direction of the common flow path.

6. The liquid ejecting head of claim 2, wherein the structural bodies include a first group of structural bodies that cyclically forms first narrowed regions at which the cross-sectional surface area is smallest in the longitudinal direction of the common flow path, a second group of structural bodies that cyclically forms second narrowed regions at which the cross-sectional surface area is next larger than the first narrowed regions, such that an interval in the longitudinal direction of the common flow path between the respective second narrowed regions is narrower than an interval in the longitudinal direction between the respective first narrowed regions, and a third group of structural bodies cyclically forms third narrowed regions at which the cross-sectional surface area is successively larger than at the second narrowed regions, such that an interval in the longitudinal direction of the common flow path between the respective third narrowed regions is successively narrower than an interval in the longitudinal direction between the respective second narrowed regions.

7. The liquid ejecting head of claim 2, wherein each of the structural bodies includes at least one columnar member disposed in a direction intersecting the longitudinal direction of the common flow path.

8. The liquid ejecting head of claim 7, wherein the cross-sectional surface area is changed depending on the number of columnar members in a direction intersecting the longitudinal direction of the common flow path.

9. The liquid ejecting head of claim 2, wherein each of the structural bodies is configured with a projection partially formed at an inner wall surface of the common flow path.

10. An image forming device comprising:
the liquid ejecting head of claim 1; and
a conveying mechanism for conveying a recording medium to a position facing the liquid ejecting head,
wherein the image forming device forms an image by causing the recording medium to pass the position facing the liquid ejecting head.
